(19) United States
(12) Patent Application Publication
(10) Pub. No.: US 2025/0225558 A1
(43) Pub. Date: Jul. 10, 2025

(54) QUERY-PRODUCT ATTRIBUTE FEATURES WITH MACHINE-LEARNING LANGUAGE LEARNING MODELS

(71) Applicant: Maplebear Inc., San Francisco, CA (US)

(72) Inventors: Aditya Subramanian, San Francisco, CA (US); Vinesh Reddy Gudla, South San Francisco, CA (US); Taesik Na, Issaquah, WA (US)

(21) Appl. No.: 19/015,493

(22) Filed: Jan. 9, 2025

Related U.S. Application Data
(60) Provisional application No. 63/619,589, filed on Jan. 10, 2024.

(51) Int. Cl. G06Q 30/0601

(52) U.S. Cl. CPC G06Q 30/0625; G06Q 30/0633

(57) ABSTRACT

An online system receives a query from a user. An online system generates a prompt to provide to a first machine learning model to determine tags associated with the query. An online system provides the prompt to the first machine learning model. An online system receives as output a set of query tags associated with the query. An online system obtains a list of ranked product tags associated with the query, wherein the product tag is ranked according to a conversion rate of products matching the product tag when users submitted a historical search query. An online system identifies a set of candidate products for the search query. An online system, for each candidate product, provides the set of features to a second machine-learning model to generate a score for the candidate and selects at least a subset of the candidate products based on the generated scores for the candidate products.

### CROSS-REFERENCE TO RELATED APPLICATIONS

This application claims the benefit of U.S. Provisional Patent Application No. 63/619,589, filed on Jan. 10, 2024, which is incorporated herein by reference in its entirety.

### BACKGROUND

An online system provides a search interface for a user to submit a search term so that a set of relevant items to the search term are retrieved. As an example, the online system may be an online platform that connects users and retailers. A user can place an order for purchasing items, such as groceries, from participating retailers via the online system, with the shopping being done by a personal shopper. When a user submits a search query, the online system may search an item catalog, identify items estimated to be relevant to the search query, and return the results to the user. However, searching a catalog using provided search terms often includes irrelevant results from partial matches. On the other hand, limiting search results to only actually relevant results requires the possibility of excluding a potentially relevant result.

### SUMMARY

In accordance with one or more aspects of the disclosure, the techniques described herein relate to a method of generating product attribute features for product queries. The online system may generate a prompt to provide to a first machine learning model to determine tags associated with the query, wherein the tags include at least product concept tags, attribute tags, and brand tags. The online system may provide the prompt to the first machine learning model. The online system may receive as output a set of query tags associated with the query. The online system may obtain a list of ranked product tags associated with the query, wherein the product tag in the list of ranked product tags is associated with a conversion rate of products matching the product tag when users submitted a historical search query that includes the search query or is related to the search query. The online system identifies a set of candidate products for the search query. The online system, for each candidate product, provides the set of features to a second machine-learning model to generate a score for the candidate product. The online system selects at least a subset of the candidate products based on the scores for the set of candidate products, and transmits instructions to the client device to cause display of the selected subset of candidate products on the client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method of generating product attribute features for product queries, in accordance with some embodiments., in accordance with one or more embodiments.

### DETAILED DESCRIPTION

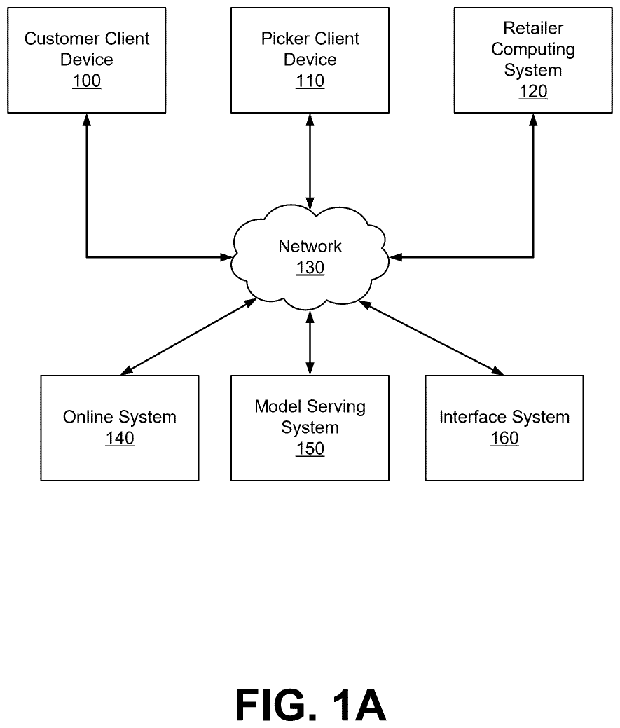

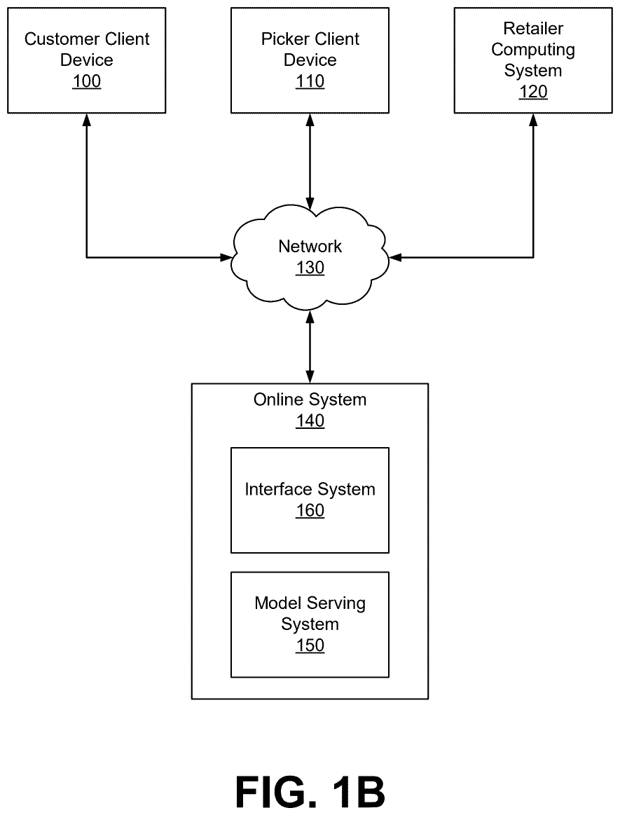

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions, etc. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. As an example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer.

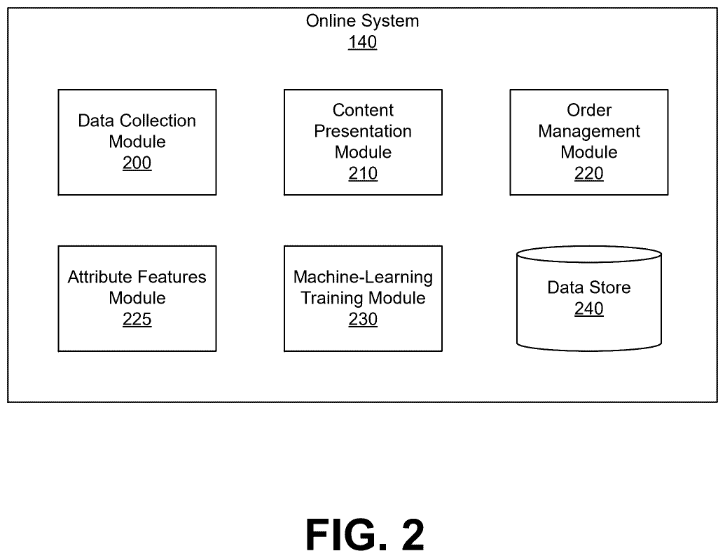

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In some embodiments, the machine-learned models deployed by the model serving system 150 are models configured to perform one or more NLP tasks. The NLP tasks include, but are not limited to, text generation, query processing, machine translation, chatbots, and the like. In some embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or

output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In some embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In some embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In some embodiments, the online system 140 generates attribute features for product queries. The online system 140 receives a query from a user. The online system 140 generates a prompt to provide to a first machine-learning model (LLM) to determine tags associated with the query, such that the tags include product tags, attribute tags, and brand tags. The online system 140 provides the prompt to the first machine-learning model. The online system 140 receives, as output, a set of query tags associated with the query. The online system 140 determines a set of candidate items responsive to the query. The online system 140 obtains a list of ranked tags associated with the query.

In one or more embodiments, the list of ranked tags is obtained by the online system 140 obtaining a list of historical queries that match the query. The online system 140 identifies, for each of the historical queries, a set of items with respect to a conversion rate. The online system 140 obtains, for each set of items associated with each historical query, associated product tags, attribute tags, and brand tags. The online system 140 determines, for each tag, a count or rate of conversion for items associated with the tag for the query. The online system 140 provides a set of features for the set of candidate items to a second machine-learning model, such that the second machine-learning model determines a score for each candidate item of the set of candidate items that indicates whether the user will interact (e.g., click, convert) on the candidate item.

In some embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in some embodiments, the online system 140 is connected to an interface system

160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In some embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a

predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The attribute features module 225 obtains tags associated with products in a catalog database. Specifically, the catalogue database may include an array of products organized by retailer, and one or more characteristics of each product, such as price, item description, availability, and the like. Tags associated with a product may include product concept tags, attribute tags, and brand tags. A product concept tag identifies a type or concept of the product. An attribute tag identifies an attribute of the product. A brand tag identifies the brand of the product. The attribute features module 225 generates a prompt to a first machine learning language model to identify a set of tags associated with the product. The first machine learning language model may be a multi-modal Large Language Model (LLM). In one or more embodiments, the prompt to the LLM for a given product in the catalog may be: “Please parse the product into words by white space. First word should be the main concept and the main concept should be as short as possible, then a semicolon, and then a list of attributes separated by commas. Show the type of attribute when possible. Show the brand when possible. The parsing should end with a period. Here is the product name and taxonomy: Product: Whole wheat thin spaghetti box. Category: food−>pantry−>pasta−>spaghetti−>spaghetti pasta.”

The attribute features module 225 receives as output from the first machine learning model, the set of tags associated with the product.

The attribute features module 225 determines a list of ranked tags for one or more historical search queries. Specifically, the attribute features module 225 obtains a list of historical queries and the attribute features module 225 identifies, for each of the historical queries, the products with a conversion rate associated with that query. For example, for a query of “cinnamon roll,” the attribute features module 225 may identify products such as different versions of cinnamon rolls, cinnamon flavored cereal, and a cinnamon cake as products that have a history of purchases associated with a query of “cinnamon roll.”

The attribute features module 225 obtains, for each set of products associated with each historical query, the associated product concept tags, attribute tags, and brand tags of the identified items. In other words, for each of the products identified as associated with the historical query of “cinnamon roll,” the attribute features module 225 logs the tags associated with the product. For example, if the product of cinnamon rolls has tags such as “cinnamon,” “roll,” “dessert,” “pastry,” “ABCinnamon,” “dairy,” and “kosher”—-these tags are logged as related to the query of “cinnamon roll.”

The attribute features module 225 determines, for each tag, a count or rate of conversion (e.g., or any other desired action) for items associated with the tag for the query. The tags used in the catalog are ranked by the rate or count of conversion. The list of ranked tags may include the list of all tags used in the catalog or may be a subset of tags with the highest rankings with respect to conversion counts or rates.

The attribute features module 225 receives a real-time query from a user. Queries often include attributes, products, and/or brands. The attribute features module 225 parses the query into identifying the attribute, product concept, and brand tags separately. The attribute features module 225 generates a prompt to provide to a first machine-learning model to determine tags associated with the query and separate out the query into product concept, attribute, and brand tags.

The attribute features module 225 provides the prompt to the LLM. The attribute features module 225 receives as output a set of query tags associated with the query. For example, for a query of “cinnamon oatmeal,” the output may include “[‘<A>: cinnamon’, ‘<P>: oatmeal’]” to indicate an attribute tag of cinnamon and a product concept tag of oatmeal in the search terms of the query.

The attribute features module 225 obtains a list of ranked tags associated with the query. The list of ranked tags may be separated by types of tags and indicate the number or rate of conversions associated with each tag as described above. To obtain a list of ranked tags associated with the query, the attribute features module 225 determines a historical query that has a similarity above a threshold (e.g., highest similarity) to the current query, and then retrieves the tags and rankings for that historical query.

For example, the attribute features module 225 may identify a relevant historical query based on the parsed query tags such as the example query of “[‘<A>: cinnamon’, ‘<P>: oatmeal’].” Regardless of the phrasing of the actual query, the attribute features module 225 may determine that the query of a combination of <A>: cinnamon’ and ‘<P>: oatmeal’ is the closest related query and provide the associated ranked tags accordingly that were obtained as described above.

For example, the list of ranked product tags for the “cinnamon oatmeal” query may include {‘<P>: oatmeal’: 1914, ‘<P>: cereal’: 33, ‘<P>: oat’: 22, ‘<P>: breakfast bars’: 11, ‘<P>: granola’: 7, ‘<P>: bread’: 5, ‘<P>: yogurt’: 4, ‘<P>: pancake mix’: 4, ‘<P>: cinnamon’: 3, ‘<P>: cooky’: 3, ‘<P>: cinnamon rolls’: 3, ‘<P>: fig bar’: 2, ‘<P>: grit’: 2, ‘<P>: rolled oats’: 2, ‘<P>: rice crisps’: 2, ‘<P>: cluster’: 2, ‘<P>: cinnamon roll’: 1, ‘<P>: french toast’: 1, ‘<P>: bar’: 1, ‘<P>: air freshener’: 1}. The list of ranked attribute tags may include {‘<A>: instant’: 1723, ‘<A>: cinnamon’: 879, ‘<A>: spice’: 590, ‘<A>: 10’: 418, ‘<A>: pack’: 365, ‘<A>: apples & cinnamon’: 292, ‘<A>: maple & brown sugar’: 240, ‘<A>: brown sugar’: 201, ‘<A>: packets’: 143, ‘<A>: cinnamon & spice’: 111, ‘<A>: maple’: 104, ‘<A>: organic’: 99, ‘<A>: cinnamon roll’: 85, ‘<A>: quick’: 81, ‘<A>: steel cut’: 79, ‘<A>: 3-minute’: 75, ‘<A>: apple’: 72, ‘<A>: protein’: 72, ‘<A>: flavor variety’: 65, ‘<A>: apple cinnamon’: 65}. The list of ranked brand tags may include {‘<B>: oatmealInc.’: 1322, ‘<B>: ABC Oatmeal’: 106, ‘<B>: Oatmeal cakes’: 89, ‘<B>: betterrr oats’: 63, ‘<B>: simply oats’: 42, ‘<B>: miller's’: 35, ‘B: ABCinnamon’: 26, ‘<B>: food and breakfast’: 24, “<B>: nature's way”: 19, ‘<B>: great value’: 16, ‘<B>: greengrain’: 16, ‘<B>: pics’: 10, ‘<B>: wild harvested oats’: 10, ‘<B>: gentleoats’: 8}.

In one or more embodiments, the attribute features module 225 first determines a set of candidate items responsive to the query at a recall layer. For example, the attribute features module 225 may search the catalog for a set of candidate products that match the query of <A>: cinnamon’ and ‘<P>: oatmeal’. For example, based on the list of ranked tags identified for the search query, the attributes feature module 225 may identify products that have the top product concept, attribute, or the brand tags as part of the set of candidate items. This way, the products identified during the recall layer are those that match the main product concepts associated with the search query, and the top attribute tags may act as filters or boost products with matching attribute tags in the ranked list.

The attribute features module 225 provides the set of candidate items and a set of features identified for each candidate item to a second machine-learning model, which is a ranking model for ranking at least a subset of the candidate items to present to the user as a response to the search query. In one or more embodiments, the set of features for a candidate item include at least one or more features obtained from the product and query tags. In some instances, a feature is the product concept click-through rate (CTR) that is computed at the <search query, product concept, product identifier> level, where CTR is defined as conversions/(impressions+k), where k is determined empirically. Another feature is the brand CTR that is computed at the <search query, brand identifier, product identifier> level. Another feature is the attribute CTR that is computed at the <search query, attribute, product identifier> level.

The attribute features module 225 applies the second machine-learning model to the set of features for a given candidate item to generate a score for each candidate item of the set of candidate items. The score for each candidate product indicates the relevance of the product to the search query and how high the product should be ranked when the results are presented to the user. As an example, a candidate product with the brand tag of “ABC Oats” which is the highest ranked brand tag for the query of <A>: cinnamon’ and ‘<P>: oatmeal’ may receive a higher score than a product with a brand tag of “greengrain” which is the lowest ranked brand tag associated with <A>: cinnamon’ and ‘<P>: oatmeal’.

The attribute features module 225 selects at least a subset of the candidate item of the set of candidate items based on the determined score of the candidate items. As an example, the attribute features module 225 may select the candidate items with a score above a predetermined threshold to select the subset of candidate items.

The attribute features module 225 transmits instructions to the user device 100 to cause display of the selected subset of candidate products on the user device 100. As a response to the search query, the attribute features module 225 transmits the subset of selected candidate products for display to the user. This way, the user may select or otherwise interact with the displayed products to add one or more products to the user's order.

In one or more embodiments, the attribute features module 225 obtains an indication that the user converted on a selected product in the subset. For example, the user may have converted on a product that was presented to the user. The attribute features module 225 generates a training example including the set of features for the selected product and a label indicating that the user converted on the selected product. For example, the label may be 1 if the user converted on the product and 0 if otherwise. The attribute features module 225 trains the set of parameters of the second machine-learning model based on the training example. The attribute features module 225 may apply the second machine-learning model on the set of features to generate an estimated output. The attribute features module 225 then computes a loss function that indicates a difference between the estimated output and the label. The attribute features module 225 backpropagates one or more terms from the loss function to update the set of parameters of the second machine-learning model.

The machine learning training module 230 trains machine learning models used by the

online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

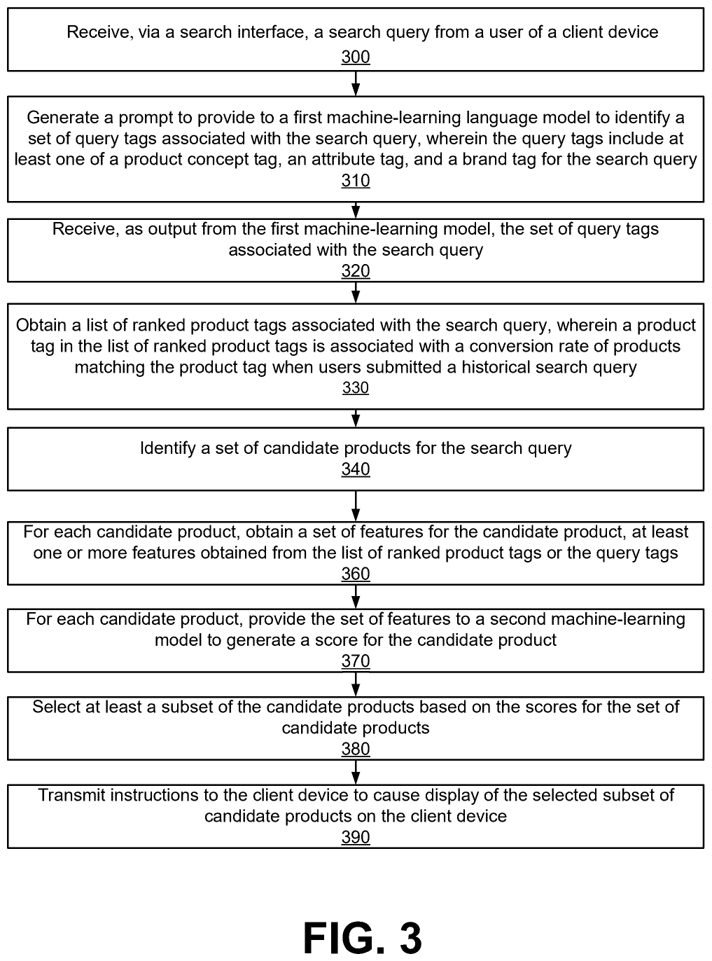

FIG. 3 is a flowchart for a method of generating product attribute features for product queries, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 300, via a search interface, a search query from a user of a client device. The online system 140 generates 310a prompt to provide to a first machine-learning language model to identify a set of query tags associated with the search query, wherein the query tags include at least one of a product concept tag, an attribute tag, and a brand tag for the search query. The online system 140 receives 320 as output from the first machine-learning model, the set of query tags associated with the query. The online system 140 obtains 330 a list of ranked product tags associated with the search query, wherein a product tag in the list of ranked product tags is associated with a conversion rate of products matching the product tag when users submitted a historical search query. The online system 140 identifies 340 a set of candidate products for the search query. For each candidate product, the online system 140 obtains 360 a set of features for the candidate product, wherein at least one or more features are obtained from the list of ranked tags. For each candidate product, the online system 140 provides 370 the set of features to a second machine-learning model to generate a score for the candidate product. The online system 140 selects 380 at least a subset of the candidate products based on the scores for the set of candidate products. The online system 140 transmits 390 instructions to the client device to cause display of the selected subset of candidate products on the client device.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, via a search interface, a search query from a client device;
generating a prompt to provide to a first machine-learning language model to identify a set of query tags associated with the search query, wherein the query tags include at least one of: a product concept tag, an attribute tag, or a brand tag for the search query;
receiving, as output from the first machine-learning model, the set of query tags associated with the search query;
obtaining a list of product tags associated with the search query, wherein a product tag in the list of product tags is associated with a conversion rate of products matching the product tag associated with a historical search query;
identifying a set of candidate products for the search query;
for each candidate product:
obtaining a set of features for the candidate product, wherein at least one or more features are obtained from the list of product tags or the set of query tags;
providing the set of features to a second machine-learning model to generate a score for the candidate product;
selecting at least a subset of the candidate products based on the scores for the set of candidate products; and
transmitting instructions to the client device to cause display of the selected subset of candidate products on the client device.

2. The method of claim 1, further comprising:
for one or more products retrieved from a catalogue database, generating a second prompt to provide to the first machine-learning model to identify a set of product tags associated with the product, wherein the product tags include at least one of: a product concept tag, an attribute tag, or a brand tag for the product; and
obtaining the set of product tags for each converted product.

3. The method of claim 2, wherein obtaining the list of product tags further comprises:
for the historical search query, identifying products that users converted on;
obtaining the set of product tags for each converted product;
identifying, for each product tag, the conversion rate of products matching the product tag; and
ranking the product tags according to the conversion rate of products matching the product tags.

4. The method of claim 1, wherein the historical search query includes the search query.

5. The method of claim 1, wherein obtaining the one or more features for the candidate product comprises obtaining one or more of: a click-through rate (CTR) received for the candidate product given the search query and the attribute tag, the brand tag, or the product concept for the search query.

6. The method of claim 1, wherein identifying the set of candidate products for the search query comprises identifying, at a recall layer, one or more candidate products that match at least one product tag in the list of product tags for the search query.

7. The method of claim 1, further comprising:
obtaining an indication of conversion for a selected product in the subset;
generating a training example including the set of features for the selected product and a label indicating conversion of the selected product; and
training one or more parameters of the second machine-learning model based on the training example.

8. The method of claim 1, further comprising:
obtaining an indication of conversion for a selected product in the subset;
generating a training example including the prompt and the output including the set of query tags; and
training one or more parameters of the first machine-learning model based on the training example.

9. A non-transitory computer-readable medium storing instructions that, when executed by one or more processors, cause the one or more processors to perform operations comprising:
receiving, via a search interface, a search query from of a client device;
generating a prompt to provide to a first machine-learning model to identify a set of query tags associated with the search query, wherein the query tags include at least one of a product concept tag, an attribute tag, or a brand tag for the search query;
receiving, as output from the first machine-learning model, the set of query tags associated with the search query;
obtaining a list of product tags associated with the search query, wherein a product tag in the list of product tags is associated with a conversion rate of products matching the product tag associated with a historical search query;
identifying a set of candidate products for the search query;
for each candidate product:
obtaining a set of features for the candidate product, wherein at least one or more features are obtained from the list of product tags or the set of query tags;
providing the set of features to a second machine-learning model to generate a score for the candidate product;
selecting at least a subset of the candidate products based on the scores for the set of candidate products; and
transmitting instructions to the client device to cause display of the selected subset of candidate products on the client device.

10. The non-transitory computer-readable medium of claim 9, further causing the one or more processors to perform operations comprising:
for one or more products retrieved from a catalogue database, generating a second prompt to provide to the first machine-learning model to identify a set of product tags associated with the product, wherein the product tags include at least one of a product concept tag, an attribute tag, or a brand tag for the product; and
obtaining the set of product tags for each converted product.

11. The non-transitory computer-readable medium of claim 10, wherein obtaining the list of tags further comprises:
for the historical search query, identifying products that users converted on the historical search query;
obtaining the set of product tags for each converted product;
identifying, for each product tag, the conversion rate of products matching the product tag; and
ranking the product tags according to the conversion rate of products matching the product tags.

12. The non-transitory computer-readable medium of claim 9, wherein the historical search query includes the search query or is related to the search query.

13. The non-transitory computer-readable medium of claim 9, wherein obtaining the one or more features for the candidate product comprises obtaining one or more of: a click-through rate (CTR) received for the candidate product given the search query and the attribute tag, the brand tag, or the product concept for the search query.

14. The non-transitory computer-readable medium of claim 9, wherein identifying the set of candidate products for the search query further comprises identifying one or more candidate products that match at least one product tag in the list or ranked product tags for the search query.

15. The non-transitory computer-readable medium of claim 9, further causing the one or more processors to perform operations comprising:
obtaining an indication of conversion for a selected product in the subset;
generating a training example including the set of features for the selected product and a label indicating conversion of the selected product; and
training one or more parameters of the second machine-learning model based on the training example.

16. The non-transitory computer-readable medium of claim 9, further comprising:
obtaining an indication of conversion for a selected product in the subset;
generating a training example including the prompt and the output including the set of query tags; and
training one or more parameters of the first machine-learning model based on the training example.

17. A system comprising:
one or more processors; and
a memory storing instructions that when executed by the one or more processors cause the system to perform operations comprising:
receiving, via a search interface, a search query from a client device;
generating a prompt to provide to a first machine-learning model to identify a set of query tags associated with the search query, wherein the query tags include at least one of a product concept tag, an attribute tag, or a brand tag for the search query;
receiving, as output from the first machine-learning model, the set of query tags associated with the query;
obtaining a list of product tags associated with the search query, wherein a product tag in the list of product tags is associated with a conversion rate of products matching the product tag associated with a historical search query;
identifying a set of candidate products for the search query;
for each candidate product:
obtaining a set of features for the candidate product, wherein at least one or more features are obtained from the list of tags;
providing the set of features to a second machine-learning model to generate a score for the candidate product;
selecting at least a subset of the candidate products based on the scores for the set of candidate products; and
transmitting instructions to the client device to cause display of the selected subset of candidate products on the client device.

18. The system of claim 17, the operations further comprising:
for one or more products retrieved from a catalogue database, generating a second prompt to provide to the first machine-learning model to identify a set of product tags associated with the product, wherein the product tags include at least one of a product concept tag, an attribute tag, or a brand tag for the product; and
obtaining the set of product tags for each converted product.

19. The system of claim 18, wherein obtaining the list of tags further comprises:
for the historical search query, identifying products that users converted on the historical search query;
obtaining the set of product tags for each converted product;
identifying, for each product tag, the conversion rate of products matching the product tag; and
ranking the product tags according to the conversion rate of products matching the product tags.

20. The system of claim 17, wherein the historical search query includes the search query.
